(19) United States
(12) Patent Application Publication
(10) Pub. No.: US 2024/0323302 A1
(43) Pub. Date: Sep. 26, 2024

(54) INFORMATION PROCESSING SYSTEM AND NON-TRANSITORY COMPUTER READABLE MEDIUM STORING PROGRAM

(71) Applicant: FUJIFILM Business Innovation Corp., Tokyo (JP)

(72) Inventor: Koichi SATO, Kanagawa (JP)

(73) Assignee: FUJIFILM Business Innovation Corp., Tokyo (JP)

(21) Appl. No.: 18/454,113

(22) Filed: Aug. 23, 2023

(30) Foreign Application Priority Data
Mar. 24, 2023 (JP) 2023-048168

(51) Int. Cl. H04N 1/32; H04W 76/14

(52) U.S. Cl. CPC H04N 1/32667; H04W 76/14

(57) ABSTRACT

An information processing system including a first device, a first virtual device, a second device, and a second virtual device, includes one or a plurality of processors configured to cause the first device to transmit nearby device information for specifying the second device, and recovery connection information used in a case where the second device connects to the first device, to the first virtual device, the first virtual device to transmit recovery connection information to the second virtual device corresponding to the second device indicated by nearby device information received from the first device, in a case where communication with the first device is not possible, the second virtual device to transmit the recovery connection information received from the first virtual device to the second device, and the second device to attempt to connect to the first device by using the recovery connection information received from the second virtual device.

### CROSS-REFERENCE TO RELATED APPLICATIONS

This application is based on and claims priority under 35 USC 119 from Japanese Patent Application No. 2023-048168 filed Mar. 24, 2023.

### BACKGROUND

### (i) Technical Field

The present disclosure relates to an information processing system and a non-transitory computer readable medium storing a program.

### (ii) Related Art

JP2022-151391A discloses an information processing device for reducing wireless communication to be performed between the information processing device and a terminal device closest to the information processing device, or a terminal device other than a terminal device possessed by a user who is in the vicinity of the information processing device in order to use the information processing device.

The information processing device includes a memory and a processor, the memory stores identification information of the present information processing device, and the processor transmits the identification information to the terminal device by using a first communication unit which is wireless proximity communication, detects communication from the terminal device, makes a connection request to the terminal device which is a source of the communication via a second communication unit, in a case where the identification information of the present information processing device is included in the communication, and performs control to establish a connection with the terminal device.

### SUMMARY

Incidentally, in recent years, a technology that virtually provides information such as functions and settings of a real device as a shadow on a cloud server and accesses the shadow from an external service to virtually implement settings and operations of the real device has been widespread, which may be referred to as a digital shadow technology. The term “device” as used herein means various devices such as an information terminal device and peripheral devices, and the term “shadow” means a virtual device that virtually represents the device.

In the digital shadow technology, synchronization is performed between the device and the shadow by communication, and the user can manage the device via the shadow of the cloud server by performing the following operations.
At least one of operations and settings on the device are performed by performing at least one of operations or settings on the shadow.
At least one of operations or settings on the device are performed and reflected on the shadow.

Therefore, in order to implement the digital shadow technology, communication for synchronizing the device with the shadow is indispensable, but there is a problem that the synchronization may not be performed due to wrong change of the network settings on the device side. In this case, the function of the digital shadow cannot be maintained. This is because normally, the device is protected by a network in a firewall, and communication from the device to the shadow (cloud server) is possible, but communication from the shadow to the device is not possible.

Aspects of non-limiting embodiments of the present disclosure relate to provide an information processing system capable of performing synchronization between a first device and a first virtual device even in a case where direct communication is not possible between the first device and the first virtual device which is a virtual device of the first device, and a non-transitory computer readable medium storing a program.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a first device, a first virtual device that is a virtual device of the first device, a second device that is present within a predetermined distance from the first device, and a second virtual device that is a virtual device of the second device, including one or a plurality of processors configured to cause: the first device to transmit nearby device information for specifying the second device, and recovery connection information used in a case where the second device connects to the first device, to the first virtual device; the first virtual device to transmit the recovery connection information to the second virtual device corresponding to the second device indicated by the nearby device information received from the first device, in a case where communication with the first device is not possible; the second virtual device to transmit the recovery connection information received from the first virtual device to the second device; and the second device to attempt to connect to the first device by using the recovery connection information received from the second virtual device.

### BRIEF DESCRIPTION OF THE DRAWINGS

Exemplary embodiment(s) of the present invention will be described in detail based on the following figures, wherein:

FIG. 1 is a block diagram illustrating an example of a configuration of an information processing system according to an exemplary embodiment of the present disclosure;

FIG. 2 is a block diagram illustrating an example of a configuration of an electrical system of a server according to the exemplary embodiment of the present disclosure;

FIG. 3 is a block diagram illustrating an example of a configuration of an electrical system of a photographing device according to the exemplary embodiment of the present disclosure;

FIG. 4 is a block diagram illustrating an example of a configuration of an electrical system of an image forming device according to the exemplary embodiment of the present disclosure;

FIG. 5 is a block diagram illustrating an example of a functional configuration of an information processing system according to an exemplary embodiment of the present disclosure;

FIG. 6 is a schematic diagram illustrating an example of a configuration of a synchronization information database according to the exemplary embodiment of the present disclosure;

FIG. 7 is a flowchart illustrating an example of a nearby device search process according to the first exemplary embodiment of the present disclosure;

FIG. 8 is a schematic diagram for explaining the nearby device search process according to a first exemplary embodiment of the present disclosure;

FIG. 9 is a schematic diagram for explaining the nearby device search process according to the first exemplary embodiment of the present disclosure;

FIG. 10 is a flowchart illustrating an example of a synchronization process according to the first exemplary embodiment of the present disclosure;

FIG. 11 is a schematic diagram for explaining the synchronization process according to the first exemplary embodiment of the present disclosure;

FIG. 12 is a schematic diagram illustrating an example of a state in which communication between a shadow and a device according to the first exemplary embodiment of the present disclosure is cut off;

FIG. 13 is a flowchart illustrating an example of a virtual device specifying process according to the exemplary embodiment of the present disclosure;

FIG. 14 is a schematic diagram for explaining the virtual device specifying process according to the exemplary embodiment of the present disclosure;

FIG. 15 is a flowchart illustrating an example of a first recovery request process according to the first exemplary embodiment of the present disclosure;

FIG. 16 is a flowchart illustrating an example of a second recovery request process according to the first exemplary embodiment of the present disclosure;

FIG. 17 is a schematic diagram for explaining the first recovery request process and the second recovery request process according to the first exemplary embodiment of the present disclosure;

FIG. 18 is a flowchart illustrating an example of a first recovery process according to the first exemplary embodiment of the present disclosure;

FIG. 19 is a schematic diagram for explaining a recovery method according to the first exemplary embodiment of the present disclosure;

FIG. 20 is a flowchart illustrating an example of a nearby device search process according to a second exemplary embodiment of the present disclosure;

FIG. 21 is a flowchart illustrating an example of a synchronization process according to the second exemplary embodiment of the present disclosure;

FIG. 22 is a flowchart illustrating an example of a first recovery request process according to the second exemplary embodiment of the present disclosure;

FIG. 23 is a flowchart illustrating an example of a second recovery request process according to a second exemplary embodiment of the present disclosure; and

FIG. 24 is a flowchart illustrating an example of a first recovery process according to the second exemplary embodiment of the present disclosure;

### DETAILED DESCRIPTION

Hereinafter, exemplary embodiments of the present disclosure will be described in detail with reference to the drawings. In addition, in the present exemplary embodiment, a case will be described where the technique of the present disclosure is applied to an information processing system that provides a service called the above-described digital shadow in which various types of data stored in a real device connected via a communication line such as the Internet are held in synchronization with the real device. Here, the real device includes various devices such as a photographing device, an image forming device, and a personal computer. Further, the various types of data include various types of data such as setting information, history information, state information, configuration information, and a destination table. Hereinafter, a case where a photographing device and an image forming device are applied as the real devices will be described.

### First Exemplary Embodiment

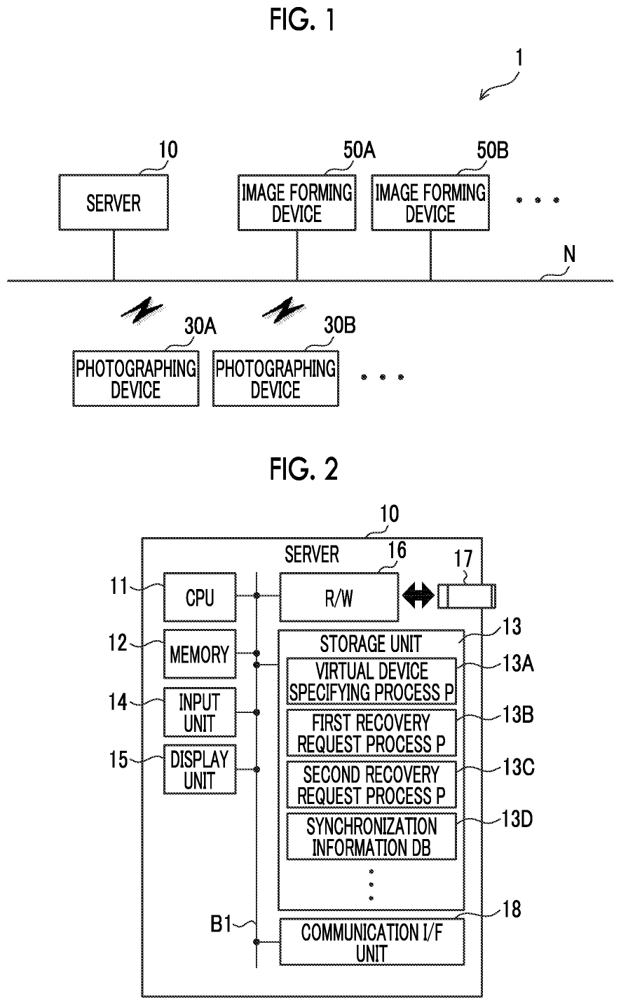

First, a configuration of an information processing system 1 according to the present exemplary embodiment will be described with reference to FIG. 1. FIG. 1 is a block diagram illustrating an example of the configuration of the information processing system 1 according to the present exemplary embodiment.

As illustrated in FIG. 1, the information processing system 1 according to the present exemplary embodiment includes a server 10 configured as a cloud server, a plurality of photographing devices 30A, 30B, . . . , and a plurality of image forming devices 50A, 50B, . . . .

In addition, hereinafter, in a case in which the photographing devices 30A, 30B, . . . are described without being distinguished from each other, the photographing devices are simply generically referred to as “photographing devices 30”. Further, hereinafter, in a case in which the image forming devices 50A, 50B, . . . are described without being distinguished from each other, the image forming devices are simply generically referred to as “image forming devices 50”.

Examples of the server 10 include information processing devices such as personal computers and server computers. Further, in the present exemplary embodiment, a digital still camera that captures a still image is applied as the photographing device 30. Further, in the present exemplary embodiment, a digital multifunction device having, for example, an image printing function, an image reading function, and an image transmission function is applied as the image forming device 50. However, the present invention is not limited to this aspect. Another image forming device, such as an image forming device having only the image printing function or an image forming device having only the image printing function and the image reading function may be applied as the image forming device 50.

The server 10, the photographing device 30, and the image forming device 50 are connected to each other via a network N, and the server 10 can communicate with the photographing device 30 and the image forming device 50 via the network N.

In addition, in the present exemplary embodiment, a combination of a public communication line, such as the Internet or a telephone network, and a communication line in a company, such as a local area network (LAN) or a wide area network (WAN), is applied as the network N. The present disclosure is not limited to this aspect. For example, only one of the public communication line and the communication line in the company may be applied as the network N. Further, in the present exemplary embodiment, wired and wireless communication lines are applied as the network N. However, the present disclosure is not limited to this aspect, and only one of the wireless communication line and the wired communication line may be applied.

Next, the configuration of the server 10 according to the present exemplary embodiment will be described with reference to FIG. 2.

FIG. 2 is a block diagram illustrating an example of a configuration of an electrical system of the server 10 according to the present exemplary embodiment.

As illustrated in FIG. 2, the server 10 according to the present exemplary embodiment includes a central processing unit (CPU) 11 as a processor, a memory 12 as a temporary storage area, a non-volatile storage unit 13, an input unit 14, such as a keyboard and a mouse, a display unit 15, such as a liquid crystal display, a medium reading/writing device (R/W) 16, and a communication interface (I/F) unit 18. The CPU 11, the memory 12, the storage unit 13, the input unit 14, the display unit 15, the medium reading/writing device 16, and the communication I/F unit 18 are connected to each other via a bus B1. The medium reading/writing device 16 reads information written on a recording medium 17 and writes information on the recording medium 17.

The storage unit 13 according to the present exemplary embodiment is realized by a hard disk drive (HDD), a solid state drive (SSD), a flash memory, or the like. The storage unit 13 as a storage medium stores a virtual device specifying process program 13A, a first recovery request process program 13B, and a second recovery request process program 13C. The recording medium 17 on which each program of the virtual device specifying process program 13A, the first recovery request process program 13B, and the second recovery request process program 13C has been written is connected to the medium reading/writing device 16, and the medium reading/writing device 16 reads each program from the recording medium 17, so that each program is stored (installed) in the storage unit 13. The CPU 11 appropriately reads each program of the virtual device specifying process program 13A, the first recovery request process program 13B, and the second recovery request process program 13C from the storage unit 13, expands the program into the memory 12, and sequentially executes processes included in each program.

Further, the storage unit 13 stores a synchronization information database 13D. The details of the synchronization information database 13D will be described later.

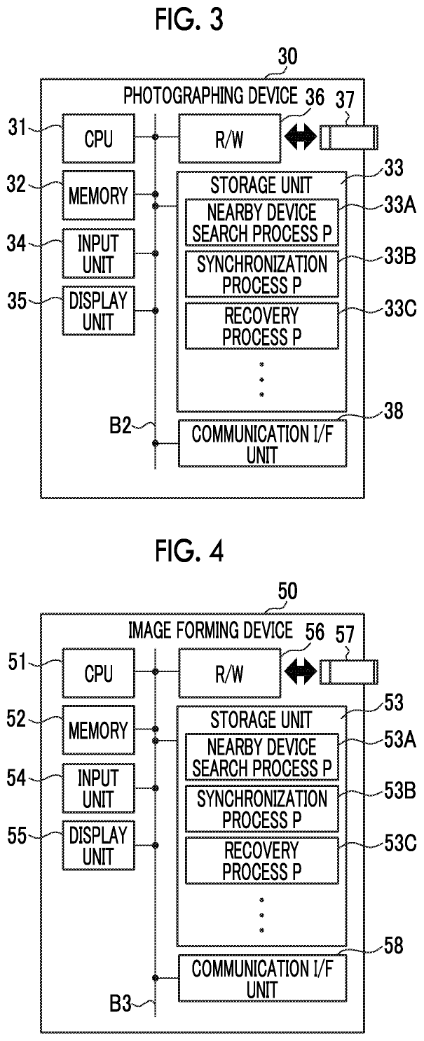

Next, a configuration of the photographing device 30 according to the present exemplary embodiment will be described with reference to FIG. 3. FIG. 3 is a block diagram illustrating an example of a configuration of an electrical system of the photographing device 30 according to the present exemplary embodiment.

As shown in FIG. 3, the photographing device 30 according to the present exemplary embodiment includes a CPU 31 as a processor, a memory 32 as a temporary storage area, a non-volatile storage unit 33, an input unit 34 such as various switches, a display unit 35 such as a liquid crystal display, a medium reading/writing device (R/W) 36, and a communication I/F unit 38. The CPU 31, the memory 32, the storage unit 33, the input unit 34, the display unit 35, the medium reading/writing device 36, and the communication I/F unit 38 are connected to each other via a bus B2. The medium reading/writing device 36 reads information written on a recording medium 37 and writes information on the recording medium 37.

The storage unit 33 according to the present exemplary embodiment is implemented by, for example, an HDD, an SSD, or a flash memory. The storage unit 33 as a storage medium stores a nearby device search process program 33A, a synchronization process program 33B, and a recovery process program 33C. The recording medium 37 on which each program of the nearby device search process program 33A, the synchronization process program 33B, and the recovery process program 33C has been written is connected to the medium reading/writing device 36, and the medium reading/writing device 36 reads each program from the recording medium 37, so that each program is stored (installed) in the storage unit 33. The CPU 31 appropriately reads each program of the nearby device search process program 33A, the synchronization process program 33B, and the recovery process program 33C from the storage unit 33, expands the program into the memory 32, and sequentially executes processes included in each program.

Next, a configuration of an image forming device 50 according to the present exemplary embodiment will be described with reference to FIG. 4. FIG. 4 is a block diagram illustrating an example of a configuration of an electrical system of the image forming device 50 according to the present exemplary embodiment.

As shown in FIG. 4, the image forming device 50 according to the present exemplary embodiment includes a CPU 51 as a processor, a memory 52 as a temporary storage area, a non-volatile storage unit 53, an input unit 54 such as various switches, a display unit 55 such as a liquid crystal display, a medium reading/writing device (R/W) 56, and a communication I/F unit 58. The CPU 51, the memory 52, the storage unit 53, the input unit 54, the display unit 55, the medium reading/writing device 56, and the communication I/F unit 58 are connected to each other via a bus B3. The medium reading/writing device 56 reads the information written in the recording medium 57 and writes information to the recording medium 57.

The storage unit 53 according to the present exemplary embodiment is realized by an HDD, SSD, flash memory, or the like. The storage unit 53 as a storage medium stores a nearby device search process program 53A, a synchronization process program 53B, and a recovery process program 53C similar to the programs stored in the photographing device 30. The recording medium 57 on which each program of the nearby device search process program 53A, the synchronization process program 53B, and the recovery process program 53C has been written is connected to the medium reading/writing device 56, and the medium reading/writing device 56 reads each program from the recording medium 57, so that each program is stored (installed) in the storage unit 53. The CPU 51 appropriately reads each program of the nearby device search process program 53A, the synchronization process program 53B, and the recovery process program 53C from the storage unit 53, expands the program into the memory 52, and sequentially executes processes included in each program.

In the information processing system 1 according to the present exemplary embodiment, each of the photographing device 30 and the image forming device 50 is the above-described real device, and a virtual device that is a virtual device of the corresponding real device is constructed on the server 10. That is, in the present exemplary embodiment, the photographing device 30 and the image forming device 50 are applied as the first device and the second device of the technique of the present disclosure.

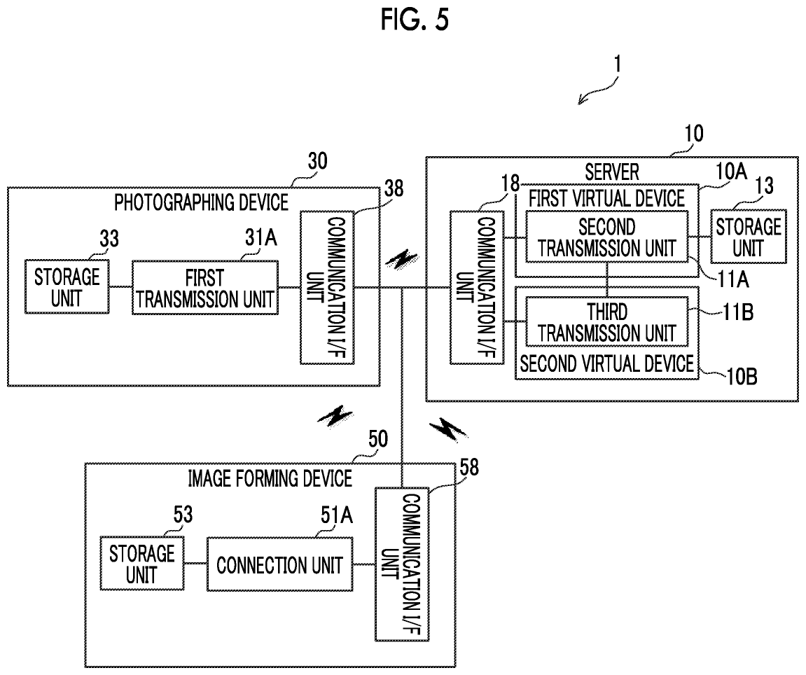

Next, a functional configuration of the information processing system 1 according to the present exemplary embodiment will be described with reference to FIG. 5. FIG. 5 is a block diagram illustrating an example of a functional configuration of the information processing system 1 according to the present exemplary embodiment. FIG. 5 illustrates, for convenience, a case where the photographing device 30 is applied as a device that can be the first device of the technique of the present disclosure and the image forming device 50 is applied as the device that can be the second device of the technique of the present disclosure.

In this case, as shown in FIG. 5, the photographing device 30 according to the present exemplary embodiment includes a first transmission unit 31A, the first virtual device 10A in the server 10 according to the present exemplary embodiment includes a second transmission unit 11A, the second virtual device 10B in the server 10 includes a third transmission unit 11B, and the image forming device 50 according to the present exemplary embodiment includes a connection unit 51A. The CPU 11 of the server 10 executes the virtual device specifying process program 13A, the first recovery request process program 13B, and the second recovery request process program 13C, thereby functioning as the second transmission unit 11A and the third transmission unit 11B. Further, in this case, the CPU 31 of the photographing device 30 executes the nearby device search process program 33A and the synchronization process program 33B to function as the first transmission unit 31A. Further, in this case, the CPU 51 of the image forming device 50 executes the recovery process program 53C to function as the connection unit 51A.

That is, in the information processing system 1 according to the present exemplary embodiment, a first virtual device 10A which is a virtual device of the first device, and a second virtual device 10B which is a virtual device of the second device which is a device close to the first device are constructed on the server 10.

Here, in a case where the first transmission unit 31A of the photographing device 30 (first device) according to the present exemplary embodiment transmits, to the first virtual device 10A, nearby device information for specifying the second device, and recovery connection information to be used in a case where the second device connects to the first device.

On the other hand, in a case where communication with the first device is not possible, the second transmission unit 11A of the first virtual device 10A in the server 10 according to the present exemplary embodiment transmits the recovery connection information to the second virtual device 10B corresponding to the second device indicated by the nearby device information received from the first device. In addition, the third transmission unit 11B of the second virtual device 10B in the server 10 according to the present exemplary embodiment transmits the recovery connection information received from the first virtual device 10A to the second device.

Then, the connection unit 51A of the image forming device 50 (second device) according to the present exemplary embodiment attempts to connect to the first device by using the recovery connection information received from the second virtual device 10B.

Here, the recovery connection information according to the present exemplary embodiment includes information indicating a connection method for the second device to connect to the first device, and the second device connects to the first device by using information indicating the connection method in the recovery connection information. In addition, the first device according to the present exemplary embodiment detects the second device by communication using a predetermined communication method.

In the present exemplary embodiment, as the communication method, short-range communication methods such as WiFi-Direct (registered trademark), Bluetooth Low Energy (registered trademark) (hereinafter, referred to as “BLE”), infrared communication, Near Field Communication (NFC), or the like are applied. Therefore, the communication I/F unit 38 of the photographing device 30 and the communication I/F unit 58 of the image forming device 50 according to the present exemplary embodiment have a communication function based on the short-range communication method (hereinafter, “short-range communication function”).

Further, in the present exemplary embodiment, as the information indicating the connection method with which the above-described second device connects to the first device, the information indicating the communication method applied in a case where the first device detects the second device is applied, but the present invention is not limited to this. For example, as the information indicating the connection method, information indicating a communication method different from the communication method applied in a case where the first device detects the second device may be applied.

In addition, the first transmission unit 31A of the first device according to the present exemplary embodiment transmits the nearby device information and the recovery connection information to the first virtual device 10A at predetermined periodic timings. In particular, in a case where synchronization with the first virtual device 10A is performed, the first transmission unit 31A of the first device according to the present exemplary embodiment transmits the nearby device information and the recovery connection information to the first virtual device 10A.

Further, the first device according to the present exemplary embodiment synchronizes with the first virtual device 10A by using the second device. In particular, the first device according to the present exemplary embodiment synchronizes with the first virtual device 10A via the second device and the second virtual device 10B.

In addition, as described above, in the example shown in FIG. 5, for convenience, a case where the photographing device 30 is applied as a device that can be the first device of the technique of the present disclosure and the image forming device 50 is applied as the device that can be the second device of the present disclosure is illustrated, but the present invention is not limited to this. For example, the image forming device 50 may be applied as a device that can be the first device of the technique of the present disclosure and the photographing device 30 may be applied as a device that can be the second device of the present disclosure, or both the photographing device 30 and the image forming device 50 may be applied as devices that can be the first device and the second device of the technique of the present disclosure. Hereinafter, a case where both the photographing device 30 and the image forming device 50 are applied as a device that can be the first device and the second device of the technique of the present disclosure will be described.

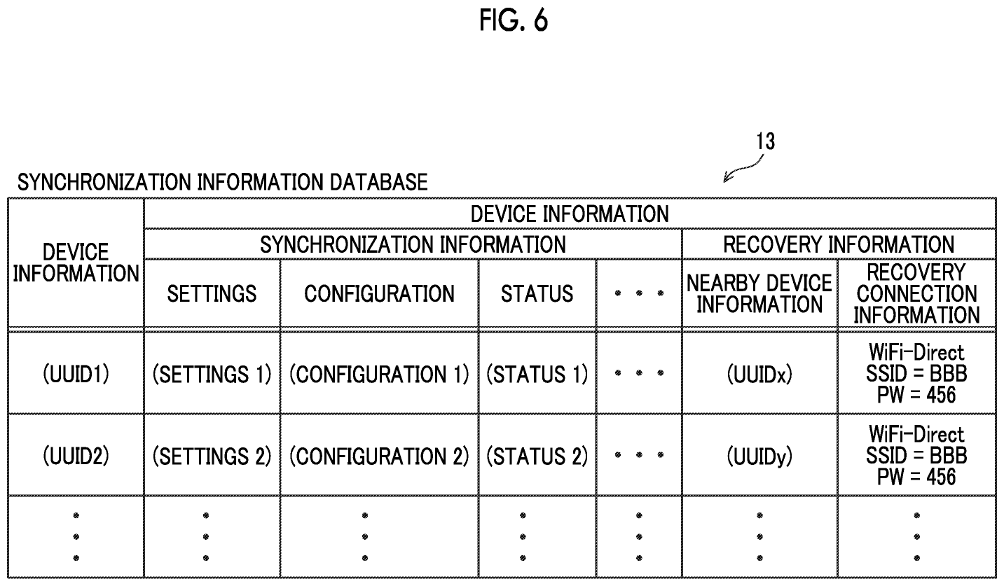

Next, the synchronization information database 13D according to the present exemplary embodiment will be described with reference to FIG. 6. FIG. 6 is a schematic diagram showing an example of a configuration of the synchronization information database 13D according to the present exemplary embodiment.

The synchronization information database 13D according to the present exemplary embodiment is a database in which information related to the above-described synchronization is registered. As illustrated in FIG. 6 as an example, device information and synchronization information are stored in association with each other.

The device information is information that is predetermined to be different for each of the first device and the second device to identify each of the first device and the second device, which are the targets of the information processing system 1. In the present exemplary embodiment, the Universally Unique Identifier (UUID) of the corresponding real device is applied as the device information, but the present invention is not limited to this. For example, a combination of the model and serial number of a corresponding real device may be applied as the device information.

The synchronization information is information indicating various types of information obtained from the real device by synchronization with the corresponding real device, and in the present exemplary embodiment, the synchronization information is classified into two types of information, device-related information and recovery information. Here, the device-related information is information such as settings, configurations, and statuses related to the corresponding real device, that is, information obtained by normal synchronization. On the other hand, the recovery information is information for recovering the synchronization in a case where the corresponding real device cannot perform synchronization for some reason, and includes the above-described nearby device information and recovery connection information. In the present exemplary embodiment, the UUID of the corresponding real device is applied as the nearby device information, but the present invention is not limited to this. For example, a combination of the model and serial number of a corresponding real device may be applied as the nearby device information as in the device information.

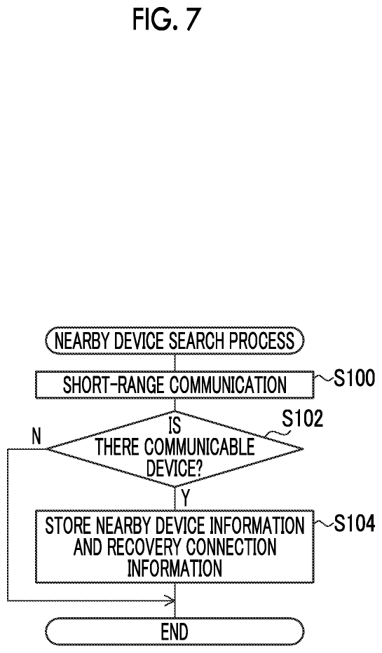

Next, the actions of the information processing system 1 according to the present exemplary embodiment will be described with reference to FIGS. 7 to 19. In a case where a specific example is described below using a schematic diagram, out of the photographing device 30 and the image forming device 50, the above-described first device is referred to as a device A, and a virtual device of the device A, that is, a first virtual device 10A is referred to as a shadow A. Similarly, out of the photographing device 30 and the image forming device 50, the above-described second device is referred to as a device B, the virtual device of the device B, that is, the second virtual device 10B is referred to as a shadow B, a device that is not close to the device A is referred to as a device C, and the virtual device of the device C is referred to as a shadow C.

First, the actions of the photographing device 30 and the image forming device 50 in a case where the nearby device search process is executed will be described with reference to FIGS. 7 to 9. FIG. 7 is a flowchart illustrating an example of a nearby device search process according to the present exemplary embodiment.

In the information processing system 1 according to the present exemplary embodiment, the nearby device search process shown in FIG. 7 is executed as an example, by the CPU 31 of the photographing device 30 and the CPU 51 of the image forming device 50 executing the nearby device search process program at predetermined timings (in the present exemplary embodiment, timings every five minutes). In the following, a case where the CPU 31 of the photographing device 30 executes the nearby device search process will be described. However, the same applies to a case where the CPU 51 of the image forming device 50 executes the nearby device search process.

In step S100 of FIG. 7, the CPU 31 attempts to communicate using the short-range communication function described above. In step S102, the CPU 31 determines whether or not there is a nearby device that is a communicable device. The CPU 31 ends the present nearby device search process in a case where a negative determination is made, while the process proceeds to step S104 in a case where a positive determination is made.

In step S104, the CPU 31 stores, in the storage unit 33, the above-described nearby device information and recovery connection information corresponding to the nearby device determined to be present, and then ends the present nearby device search process.

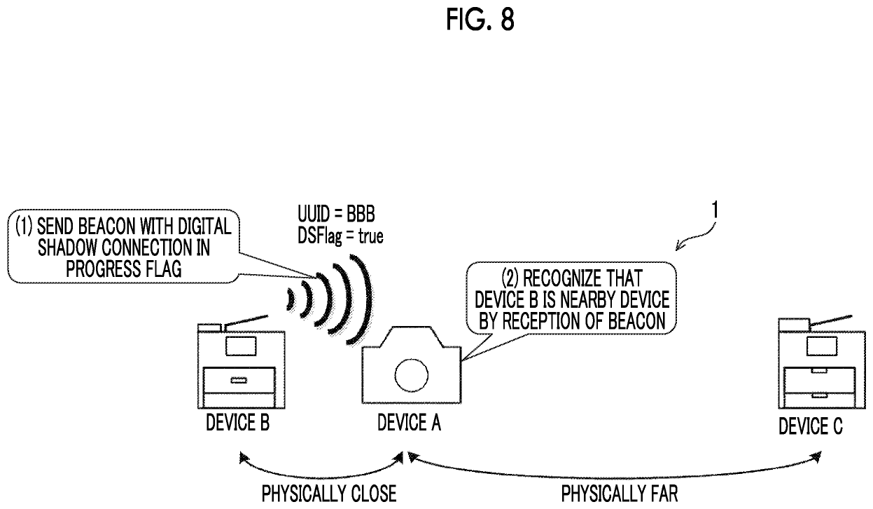

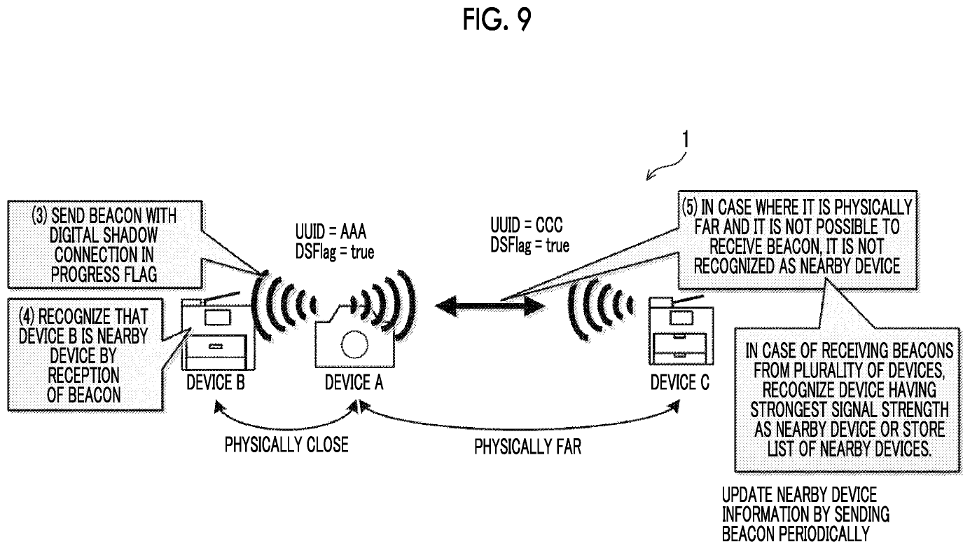

FIGS. 8 and 9 are schematic diagrams for explaining the nearby device search process according to the present exemplary embodiment.

In the present exemplary embodiment, as illustrated in FIG. 8 as an example, the device B sends a beacon with a digital shadow connection in progress flag, by using the beacon function of the BLE. In response to this, by reception of the beacon from the device B, the device A recognizes that the device B is a nearby device that is a device physically close to the device A.

Similarly, as illustrated in FIG. 9 as an example, the device A also sends a beacon, so that the device B recognizes that the device A is a nearby device that is a device physically close to the device B. On the other hand, since the device C is physically far from the device A and the device B, the device C cannot receive the beacon from the device A and the device B. Similarly, since the device A and the device B cannot receive the beacon from the device C, the device A and the device B are not recognized as nearby devices to each other.

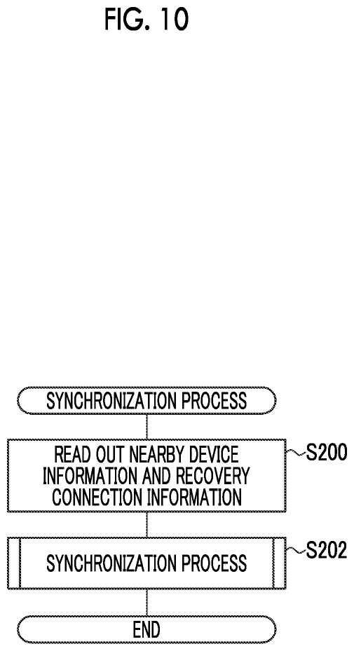

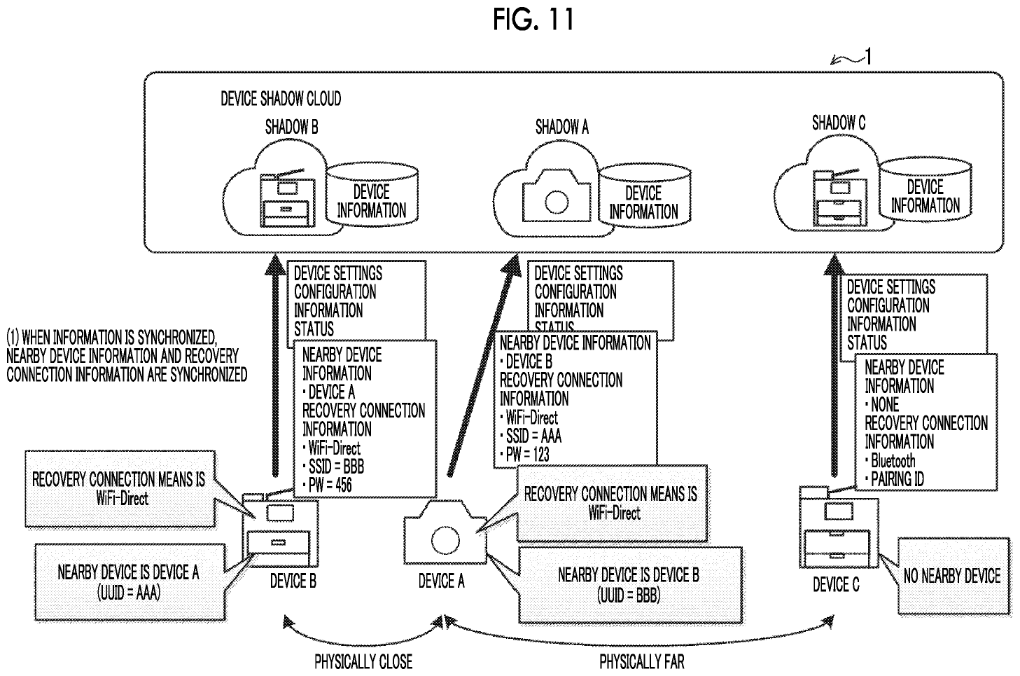

Next, the actions of the photographing device 30 and the image forming device 50 in a case where the synchronization process is executed will be described with reference to FIGS. 10 and 11. FIG. 10 is a flowchart illustrating an example of the synchronization process according to the present exemplary embodiment.

In the information processing system 1 according to the present exemplary embodiment, the synchronization process shown in FIG. 10 is executed as an example, by the CPU 31 of the photographing device 30 and the CPU 51 of the image forming device 50 executing the synchronization process program at predetermined timings (in the present exemplary embodiment, timings every 10 minutes). In the following, a case where the CPU 31 of the photographing device 30 executes the synchronization process will be described. However, the same applies to a case where the CPU 51 of the image forming device 50 executes the synchronization process.

In step S200 of FIG. 10, in the nearby device search process described above, the CPU 31 reads out the nearby device information and the recovery connection information stored in the storage unit 33 after the last time the present synchronization process is performed. In step S202, the CPU 31 synchronizes with the corresponding virtual device (shadow) including the read nearby device information and the recovery connection information, and then ends the present synchronization process. By the above synchronization process, the synchronization information database 13D shown in FIG. 6 is constructed (updated) as an example.

FIG. 11 is a schematic diagram for explaining the synchronization process according to the present exemplary embodiment.

In the information processing system 1 according to the present exemplary embodiment, as shown in FIG. 11 as an example, information held by each device and information held by each shadow are periodically synchronized with each other. The information to be synchronized is generally settings, configurations, and statuses of a device. In each device according to the present exemplary embodiment, in a case of synchronization, synchronization is performed for the nearby device information and the recovery connection information in addition to the usual information. In the present exemplary embodiment, device information detected in the corresponding nearby device search process (in the present exemplary embodiment, the UUID of BLE as an example) is applied as the nearby device information, and information (in the present exemplary embodiment, connection information of a WiFi-Direct (registered trademark) as an example) used in a case where another device accesses each device is applied as the recovery connection information.

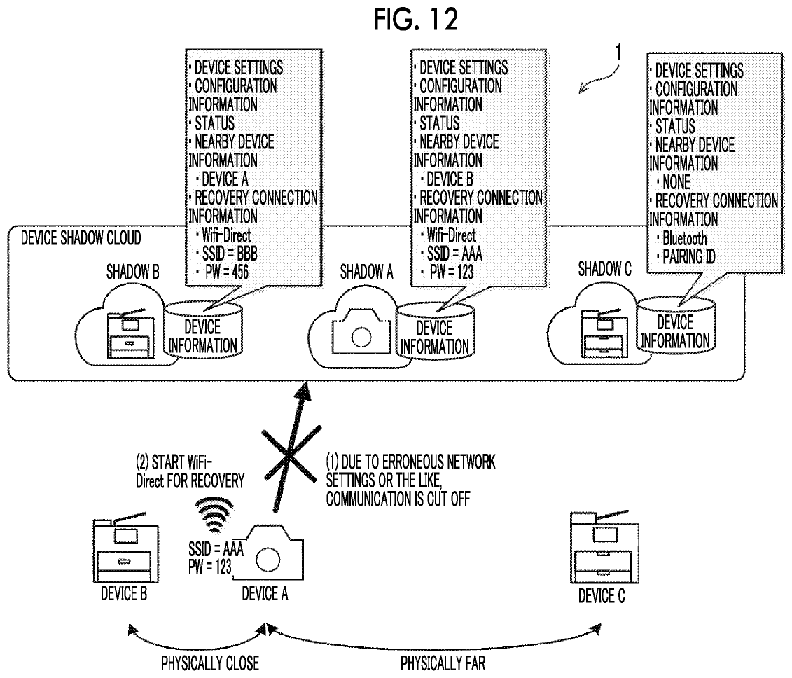

Incidentally, in the information processing system 1 according to the present exemplary embodiment, as shown in FIG. 12 as an example, communication between the device and the corresponding shadow may not be possible due to erroneous network settings or the like in any device (device A in the example shown in FIG. 12). In this case, the shadow according to the present exemplary embodiment starts communication for recovery connection (communication by WiFi-Direct (registered trademark) in the present exemplary embodiment) and waits for a connection from another device. Further, FIG. 12 is a schematic diagram illustrating an example of a state in which communication between a shadow and a device according to the present exemplary embodiment is cut off.

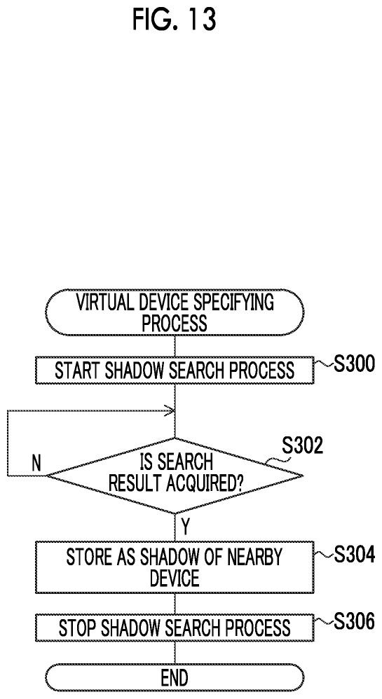

In this case, the CPU 11 of the server 10 on which the shadows according to the present exemplary embodiment are constructed executes the virtual device specifying process program 13A as the first virtual device 10A, whereby the virtual device specifying process shown in FIG. 13 is executed as an example. FIG. 13 is a flowchart illustrating an example of the virtual device specifying process according to the present exemplary embodiment.

In step S300 of FIG. 13, the CPU 11 reads out the nearby device information corresponding to the real device corresponding to the CPU 11 from the synchronization information database 13D. Then, the CPU 11 starts a process of searching for a shadow of the device indicated by the nearby device information by using the read nearby device information, and waits until a search result is acquired, in step S302.

In step S304, the CPU 11 considers that the searched shadow is a shadow of the device indicated by the nearby device information, and stores information (hereinafter, referred to as “shadow specifying information”) that can specify the shadow in the present storage unit 13. In step S306, the CPU 11 stops the search process started by the process of step S300, and then ends the virtual device specifying process.

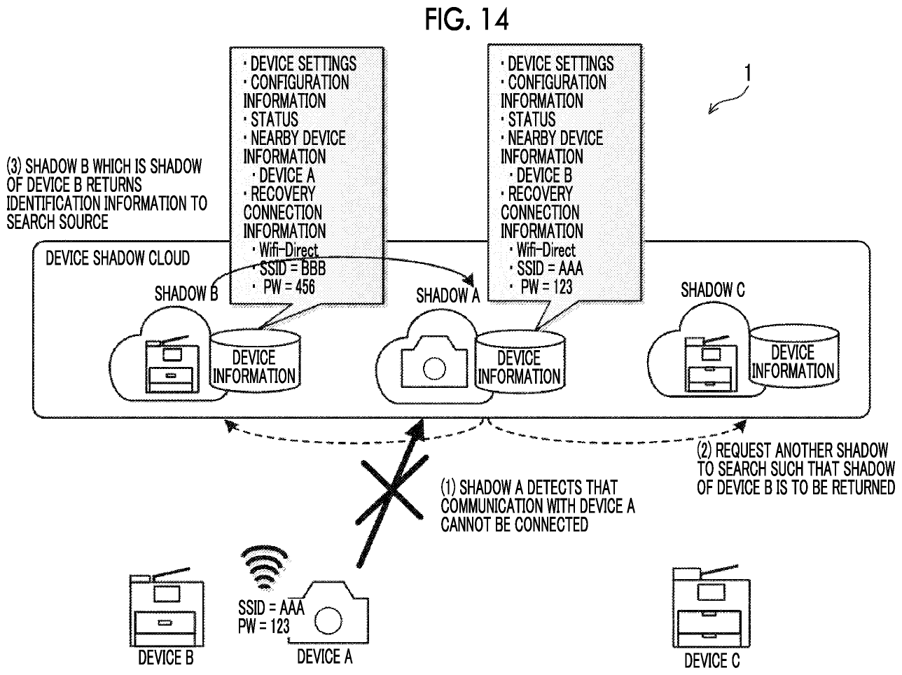

FIG. 14 is a schematic diagram for explaining the virtual device specifying process according to the present exemplary embodiment.

As an example, as shown in FIG. 14, in the virtual device specifying process according to the present exemplary embodiment, in a case where the shadow A detects that the connection with the device A is cut off, the shadow A searches for the shadow of the device indicated by the nearby device information as described above. Among the shadows that have received the search request, the shadow B whose connection destination is the device B returns the identification information of the shadow B to the shadow A that is the search request source. Accordingly, the shadow A can specify that the shadow of the device B is the shadow B.

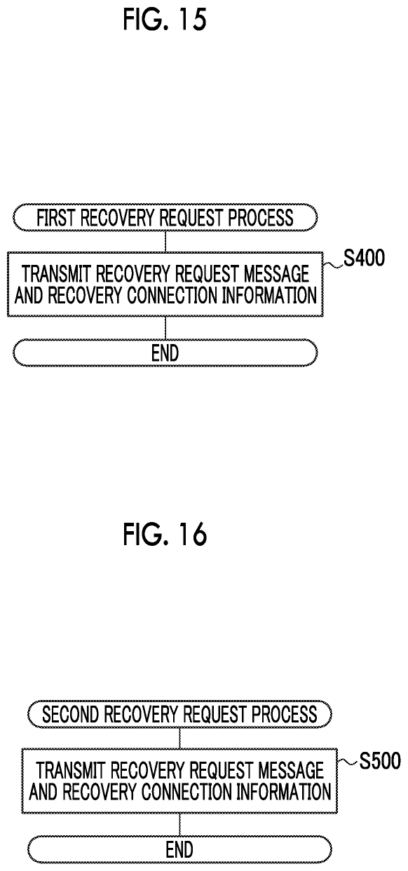

In a case where the above virtual device specifying process is ended, the CPU 11 of the server 10 executes the first recovery request process program 13B as the first virtual device 10A, thereby executing the first recovery request process shown in FIG. 15 as an example. FIG. 15 is a flowchart illustrating an example of the first recovery request process according to the present exemplary embodiment.

In step S400 of FIG. 15, the CPU 11 transmits a recovery request message requesting recovery of the communication and the corresponding recovery connection information, to the shadow indicated by the shadow specifying information specified by the virtual device specifying process and stored in the storage unit 13, and then ends the present first recovery request process.

On the other hand, in a case of receiving the recovery request message and the recovery connection information, the CPU 11 of the server 10 executes the second recovery request process program 13C as the second virtual device 10B, thereby executing the second recovery request process shown in FIG. 16 as an example. FIG. 16 is a flowchart illustrating an example of the second recovery request process according to the present exemplary embodiment.

In step S500 of FIG. 16, the CPU 11 transmits the received recovery request message and recovery connection information to the device to be synchronized with the CPU 11, and then ends the present second recovery request process.

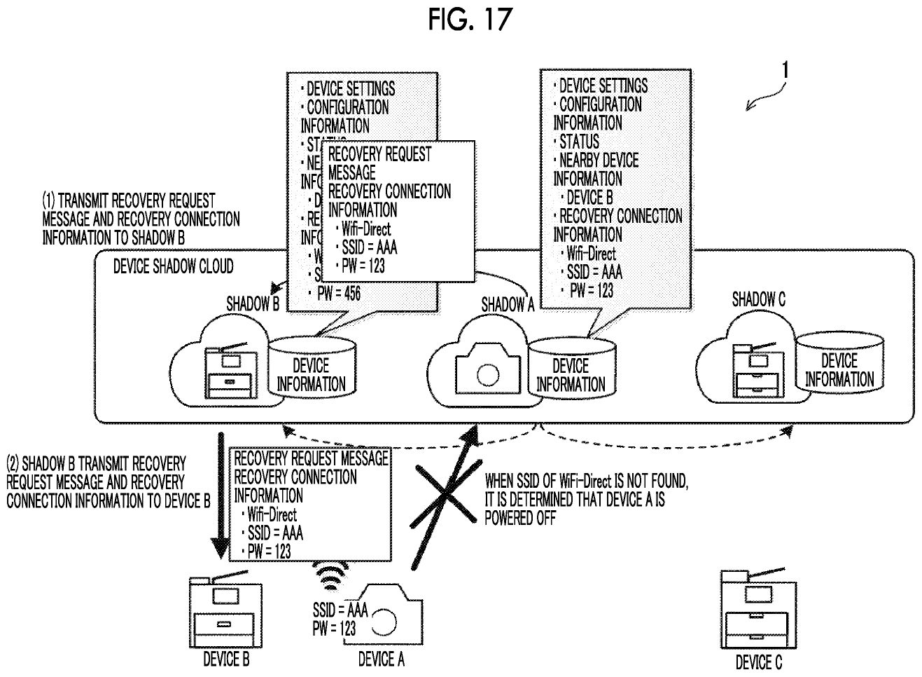

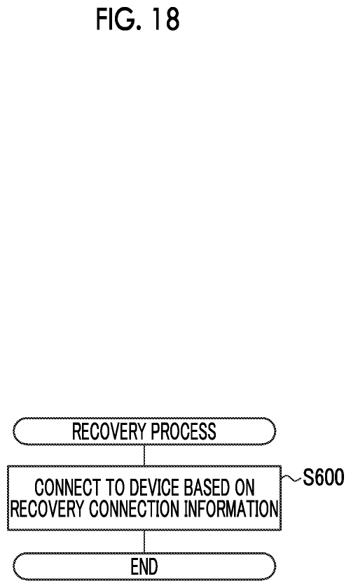

FIG. 17 is a schematic diagram for explaining the first recovery request process and the second recovery request process according to the present exemplary embodiment. As an example, as shown in FIG. 17, in a case where the shadow A loses communication with the corresponding device A, the shadow A executes the first recovery request process, so that the recovery request message and the recovery connection information are transmitted to the shadow B specified by the virtual device specifying process. Then, the shadow B transmits the recovery request message and the recovery connection information received from the shadow A to the device B by executing the second recovery request process. On the other hand, in a case where the recovery request message and the recovery connection information are received, the CPU 31 of the photographing device 30 or the CPU 51 of the image forming device 50, which is the corresponding device, executes the recovery process program 33C or the recovery process program 53C, so that the recovery process shown in FIG. 18 is executed. In the following, a case where the CPU 31 of the photographing device 30 executes the recovery process will be described. However, the same applies to a case where the CPU 51 of the image forming device 50 executes the recovery process.

In step S600 of FIG. 18, the CPU 31 connects to the corresponding device using the recovery connection information received from the server 10, and then ends the present recovery process. By this recovery process, a device that cannot communicate with the shadow and a device that is close to the device can communicate with each other. Therefore, after that, in the information processing system 1 according to the present exemplary embodiment, the device that cannot communicate with the shadow is recovered as follows.

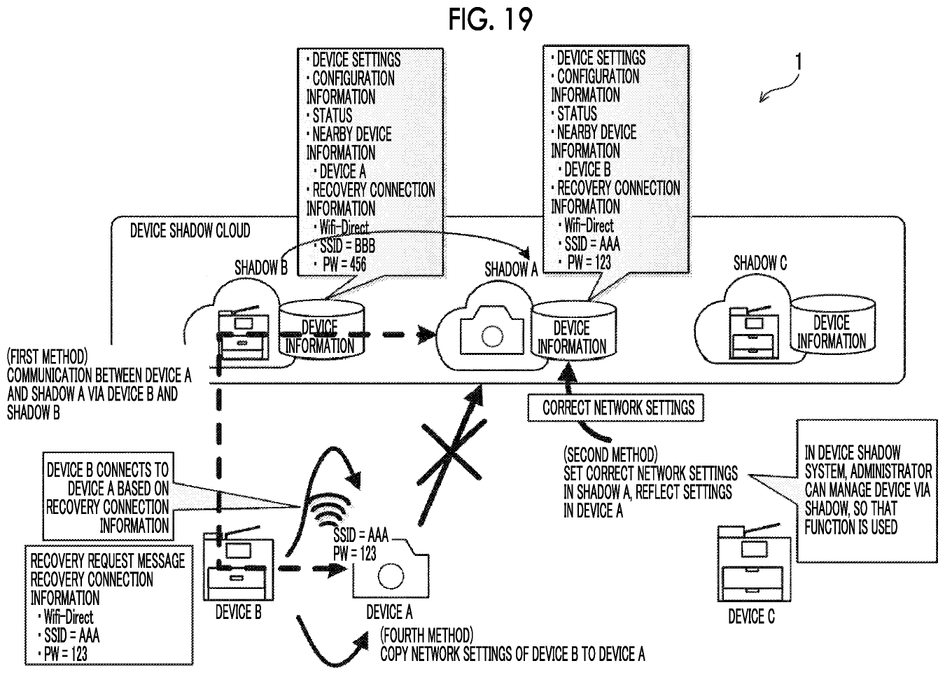

Hereinafter, the following four types of methods will be described as the recovery method with reference to FIG. 19. FIG. 19 is a schematic diagram for explaining the recovery method according to the present exemplary embodiment. In the following description, a device that cannot communicate with the shadow is referred to as a device A, and a device capable of short-range communication with the device A is referred to as a device B.

### First Method

Information is synchronized in the route of device A→device B→shadow B→shadow A. With this method, simple recovery is possible.

### Second Method

The administrator sets the correct network settings in the shadow A and synchronizes the settings with the first method to recover the communication between the device A and the shadow A. In this case, from the server 10, information indicating that the device A cannot communicate with the shadow A is transmitted to the administrator together with information indicating the network settings when the device A and the shadow A can communicate with each other. The administrator who has received the information reflects the information different from the network settings indicated by the received information, in the network settings of the shadow A, by using the information.

### Third Method

By synchronizing the network settings when the device A and the shadow A can communicate with each other with the first method, the communication between the device A and the shadow A is recovered. That is, since the correct network settings of the device A is originally obtained in the shadow A by synchronization, the shadow A and the device A synchronize via the communication route established by the first method, and the network settings are reflected in the device A, so that the network settings of the device A are normalized.

### Fourth Method

By copying the network settings (Proxy information, Domain Name System (DNS) information, and the like) possessed by the device B to the device A, the communication between the device A and the shadow A is recovered.

### Second Exemplary Embodiment

In the present exemplary embodiment, an aspect example of a case where recovery connection information is not transmitted to the shadow, but is transmitted to a nearby device and used for recovery will be described. Since the configuration of the information processing system 1 according to the present exemplary embodiment is substantially the same as that according to the first exemplary embodiment, the description thereof will be omitted here.

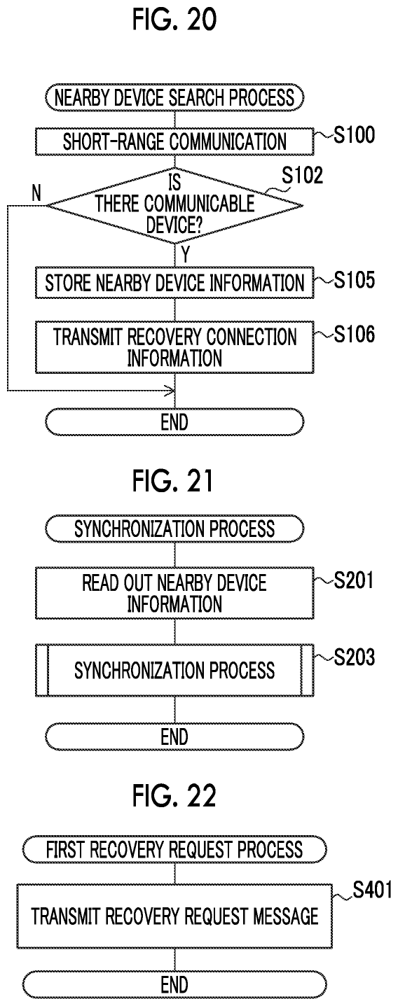

Hereinafter, the actions of the information processing system 1 according to the present exemplary embodiment will be described with reference to FIGS. 20 to 24.

First, the actions of the photographing device 30 and the image forming device 50 in a case where the nearby device search process is executed will be described with reference to FIG. 20. FIG. 20 is a flowchart illustrating an example of a nearby device search process according to the present exemplary embodiment.

In the information processing system 1 according to the present exemplary embodiment, the nearby device search process shown in FIG. 20 is executed as an example, by the CPU 31 of the photographing device 30 and the CPU 51 of the image forming device 50 executing the nearby device search process program at predetermined timings (in the present exemplary embodiment, timings every five minutes). In the following, a case where the CPU 31 of the photographing device 30 executes the nearby device search process will be described. However, the same applies to a case where the CPU 51 of the image forming device 50 executes the nearby device search process.

In step S100 of FIG. 20, the CPU 31 attempts to communicate using the short-range communication function described above. In step S102, the CPU 31 determines whether or not there is a nearby device that is a communicable device. The CPU 31 ends the present nearby device search process in a case where a negative determination is made, while the process proceeds to step S105 in a case where a positive determination is made.

In step S105, the CPU 31 stores the above-described nearby device information corresponding to the nearby device determined to be present, in the storage unit 33. In step S106, the CPU 31 transmits the above-described recovery connection information corresponding to the nearby device determined to be present to the nearby device, and then ends the present nearby device search process. In a case of receiving the recovery connection information, the nearby device stores the recovery connection information in the storage unit.

Next, the actions of the photographing device 30 and the image forming device 50 in a case where the synchronization process is executed will be described with reference to FIG. 21. FIG. 21 is a flowchart illustrating an example of the synchronization process according to the present exemplary embodiment.

In the information processing system 1 according to the present exemplary embodiment, the synchronization process shown in FIG. 21 is executed as an example, by the CPU 31 of the photographing device 30 and the CPU 51 of the image forming device 50 executing the synchronization process program at predetermined timings (in the present exemplary embodiment, timings every 10 minutes). In the following, a case where the CPU 31 of the photographing device 30 executes the synchronization process will be described. However, the same applies to a case where the CPU 51 of the image forming device 50 executes the synchronization process.

In step S201 of FIG. 21, in the nearby device search process described above, the CPU 31 reads out the nearby device information stored in the storage unit 33 after the last time the present synchronization process is performed. In step S203, the CPU 31 synchronizes with the corresponding virtual device (shadow) including the read nearby device information, and then ends the present synchronization process.

Incidentally, even in the information processing system 1 according to the present exemplary embodiment, as shown in FIG. 12 as an example, communication between the device and the corresponding shadow may not be possible due to erroneous network settings or the like in any device (device A in the example shown in FIG. 12). In this case, the shadow according to the present exemplary embodiment starts communication for recovery connection (communication by WiFi-Direct (registered trademark) in the present exemplary embodiment) and waits for a connection from another device.

The present exemplary embodiment is the same as in the first exemplary embodiment in that in this case, the virtual device specifying process shown in FIG. 13 is executed as an example, by the CPU 11 of the server 10 on which the shadow according to the present exemplary embodiment is constructed executing the virtual device specifying process program 13A as the first virtual device 10A.

In a case where the virtual device specifying process is ended, the CPU 11 of the server 10 executes the first recovery request process program 13B as the first virtual device 10A, thereby executing the first recovery request process shown in FIG. 22 as an example. FIG. 22 is a flowchart illustrating an example of the first recovery request process according to the present exemplary embodiment.

In step S401 of FIG. 22, the CPU 11 transmits a recovery request message requesting recovery of the communication and corresponding to the instruction information in the technique of the present disclosure, to the shadow indicated by the shadow specifying information specified by the virtual device specifying process and stored in the storage unit 13, and then ends the present first recovery request process.

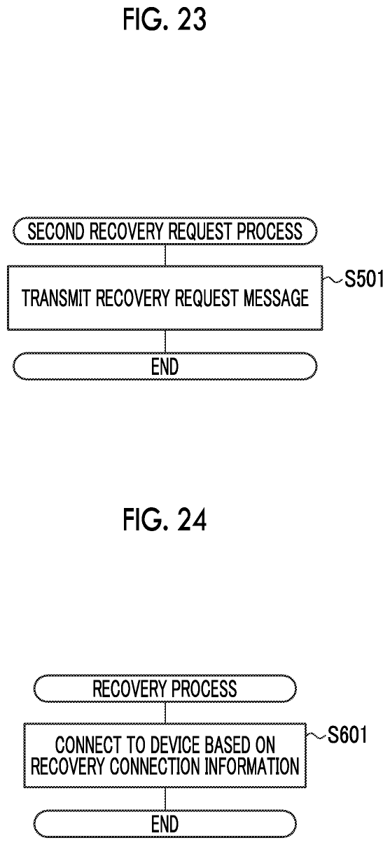

On the other hand, in a case of receiving the recovery request message, the CPU 11 of the server 10 executes the second recovery request process program 13C as the second virtual device 10B, thereby executing the second recovery request process shown in FIG. 23 as an example. FIG. 23 is a flowchart illustrating an example of the second recovery request process according to the present exemplary embodiment.

In step S501 of FIG. 23, the CPU 11 transmits the received recovery request message to the device to be synchronized with the CPU 11, and then ends the present second recovery request process.

On the other hand, in a case where the recovery request message is received, the CPU 31 of the photographing device 30 or the CPU 51 of the image forming device 50, which is the corresponding device, executes the recovery process program 33C or the recovery process program 53C, so that the recovery process shown in FIG. 24 is executed. In the following, a case where the CPU 31 of the photographing device 30 executes the recovery process will be described. However, the same applies to a case where the CPU 51 of the image forming device 50 executes the recovery process.

In step S601 of FIG. 24, the CPU 31 connects to the corresponding device using the recovery connection information stored in response to the nearby device search process described above, and then ends the present recovery process.

After that, recovering the device that cannot communicate with the shadow by the first to fourth methods described above is the same as the information processing system 1 according to the first exemplary embodiment.

In each of the above exemplary embodiments, a case where a shadow of a nearby device is detected by performing a shadow search has been described, but the present invention is not limited to this. For example, device information on all devices targeted by the information processing system 1 and information for specifying the corresponding shadow may be registered as table information or the like in association with each other in the storage unit 13 of the server 10, and the shadow of the nearby device may be specified by referring to the table information or the like.

Further, in each of the above exemplary embodiments, a case where the synchronization information database 13D is registered in the server 10 has been described, but the present invention is not limited to this. For example, the synchronization information database 13D may be registered in any one of the photographing device 30 and the image forming device 50 or another device accessible from any one of the photographing device 30 and the image forming device 50.

Further, in each of the above exemplary embodiments, the case where the photographing device 30 and the image forming device 50 are applied as the first device and the second device in the present disclosure has been described, but the present disclosure is not limited thereto. For example, another device to which the digital shadow technology can be applied, such as a personal computer or a mobile information terminal, may be applied as the first device and the second device of the present disclosure.

In addition, in each of the above-described exemplary embodiments, a case where synchronization with the first virtual device cannot be performed because the first device is in the power-off state or the sleep state is not considered, but this case may be considered.

As an aspect example in this case, a form can be illustrated in which specifying information for specifying the second device is included in the recovery connection information, and the second device checks whether or not the first device is in a power-off state or a sleep state by using the specifying information.

According to this aspect, in a case where communication between the first device and the first virtual device is not possible, the specifying information is transmitted from the first virtual device to the second device via the second virtual device. Therefore, the second device performs an operation of causing the first device to release the sleep state by starting a test job or the like by using the received specifying information.

After that, the first virtual device checks the connection state with the first device again, and determines that the first device is in the power-off state in a case where there is still no response from the first device.

According to this aspect, it is possible to take measures in a case where the cause of the inability to communicate between the first device and the first virtual device is the power-off state or the sleep state of the first device.

Further, in each of the above-described exemplary embodiments, the case where the nearby device information and the recovery connection information are transmitted from the real device to the virtual device at the timing of performing the synchronization has been described, but the present invention is not limited thereto. For example, the information may be transmitted from the real device to the virtual device at predetermined periodic timings, regardless of synchronization with the virtual device.

The exemplary embodiment has been described above. However, the technical scope of the present invention is not limited to the scope described in the above-described exemplary embodiment. Various modifications or improvements of the above-described exemplary embodiment can be made without departing from the gist of the invention, and the modified or improved exemplary embodiments are also included in the technical scope of the present invention.

Further, each of the above exemplary embodiments does not limit the invention according to the claim, and not all combinations of characteristics described in the exemplary embodiments are indispensable for the means for addressing the invention. The above-described exemplary embodiment includes inventions at various stages, and various inventions are extracted by combinations of a plurality of disclosed constituent elements. Even in a case where some constituent elements are deleted from all the constituent elements shown in the exemplary embodiments, as long as an effect is obtained, a configuration in which the some constituent elements are deleted can be extracted as an invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the configurations of the server 10, the photographing device 30, and the image forming device 50 described in each of the above exemplary embodiments are examples, and unnecessary parts may be deleted or new parts may be added within a range that does not deviate from the gist of the present invention.

Further, the flows of various processing described in each of the above exemplary embodiments are also examples, needless to say, unnecessary steps may be deleted, new steps may be added, or the processing order may be changed without departing from the gist of the present invention.

### Supplementary Notes

(((1)))

An information processing system including a first device, a first virtual device that is a virtual device of the first device, a second device that is present within a predetermined distance from the first device, and a second virtual device that is a virtual device of the second device, the system comprising:
one or a plurality of processors configured to cause:
the first device to
transmit nearby device information for specifying the second device, and recovery connection information used in a case where the second device connects to the first device, to the first virtual device;
the first virtual device to
transmit the recovery connection information to the second virtual device corresponding to the second device indicated by the nearby device information received from the first device, in a case where communication with the first device is not possible;
the second virtual device to
transmit the recovery connection information received from the first virtual device to the second device; and
the second device to
attempt to connect to the first device by using the recovery connection information received from the second virtual device.
   (((2)))

The information processing system according to (((1))),
wherein the recovery connection information includes information indicating a connection method with which the second device connects to the first device, and
the second device connects to the first device by using the information indicating the connection method in the recovery connection information.
   (((3)))

The information processing system according to (((1))) or (((2))),
wherein the recovery connection information includes specifying information for specifying the second device, and
the second device checks whether or not the first device is in a power-off state or a sleep state by using the specifying information in the recovery connection information.
   (((4)))

The information processing system according to any one of (((1))) to (((3))),
wherein the first device detects the second device via communication using a predetermined communication method.
   (((5)))

The information processing system according to (((4))),
wherein the communication method is a short-range communication method.
   (((6)))

The information processing system according to any one of (((1)) to (((5))),
wherein the first device transmits the nearby device information and the recovery connection information to the first virtual device, at predetermined periodic timings.
   (((7)))

The information processing system according to (((6))),
wherein the first device transmits the nearby device information and the recovery connection information to the first virtual device, in a case of synchronizing with the first virtual device.
   (((8)))

The information processing system according to any one of (((1))) to (((7))),
wherein the first device synchronizes with the first virtual device by using the second device.
   (((9)))

The information processing system according to (((8))),
wherein the first device synchronizes with the first virtual device via the second device and the second virtual device.
   (((10)))

The information processing system according to (((8))),
wherein the first device synchronizes with the first virtual device by setting setting information related to communication of the second device in the first device.
   (((11)

An information processing system including a first device, a first virtual device that is a virtual device of the first device, a second device that is present within a predetermined distance from the first device, and a second virtual device that is a virtual device of the second device, the system comprising:
one or a plurality of processors configured to cause:
the first device to
transmit nearby device information for specifying the second device to the first virtual device, and transmit recovery connection information used in a case where the second device connects to the first device, to the second device;
the first virtual device to
transmit instruction information indicating an instruction to recover the first device to the second virtual device corresponding to the second device indicated by the nearby device information received from the first device, in a case where communication with the first device is not possible;
the second virtual device to
transmit the instruction information received from the first virtual device to the second device; and
the second device to
attempt to connect to the first device by using the recovery connection information received from the first device, in a case where the instruction information is received from the second virtual device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system including a first device, a first virtual device that is a virtual device of the first device, a second device that is present within a predetermined distance from the first device, and a second virtual device that is a virtual device of the second device, the system comprising:
one or a plurality of processors configured to cause:
the first device to
transmit nearby device information for specifying the second device, and recovery connection information used in a case where the second device connects to the first device, to the first virtual device;
the first virtual device to
transmit the recovery connection information to the second virtual device corresponding to the second device indicated by the nearby device information received from the first device, in a case where communication with the first device is not possible;
the second virtual device to
transmit the recovery connection information received from the first virtual device to the second device; and
the second device to
attempt to connect to the first device by using the recovery connection information received from the second virtual device.

2. The information processing system according to claim 1,
wherein the recovery connection information includes information indicating a connection method with which the second device connects to the first device, and
the second device connects to the first device by using the information indicating the connection method in the recovery connection information.

3. The information processing system according to claim 1,
wherein the recovery connection information includes specifying information for specifying the second device, and
the second device checks whether or not the first device is in a power-off state or a sleep state by using the specifying information in the recovery connection information.

4. The information processing system according to claim 2,
wherein the recovery connection information includes specifying information for specifying the second device, and
the second device checks whether or not the first device is in a power-off state or a sleep state by using the specifying information in the recovery connection information.

5. The information processing system according to claim 1,
wherein the first device detects the second device via communication using a predetermined communication method.

6. The information processing system according to claim 5,
wherein the communication method is a short-range communication method.

7. The information processing system according to claim 1,
wherein the first device transmits the nearby device information and the recovery connection information to the first virtual device, at predetermined periodic timings.

8. The information processing system according to claim 7,
wherein the first device transmits the nearby device information and the recovery connection information to the first virtual device, in a case of synchronizing with the first virtual device.

9. The information processing system according to claim 1,
wherein the first device synchronizes with the first virtual device by using the second device.

10. The information processing system according to claim 9,
wherein the first device synchronizes with the first virtual device via the second device and the second virtual device.

11. The information processing system according to claim 9,
wherein the first device synchronizes with the first virtual device by setting setting information related to communication of the second device in the first device.

12. An information processing system including a first device, a first virtual device that is a virtual device of the first device, a second device that is present within a predetermined distance from the first device, and a second virtual device that is a virtual device of the second device, the system comprising:
one or a plurality of processors configured to cause:
the first device to
transmit nearby device information for specifying the second device to the first virtual device, and transmit recovery connection information used in a case where the second device connects to the first device, to the second device;
the first virtual device to
transmit instruction information indicating an instruction to recover the first device to the second virtual device corresponding to the second device indicated by the nearby device information received from the first device, in a case where communication with the first device is not possible;
the second virtual device to
transmit the instruction information received from the first virtual device to the second device; and
the second device to
attempt to connect to the first device by using the recovery connection information received from the first device, in a case where the instruction information is received from the second virtual device.

13. A non-transitory computer readable medium storing a program executed by a first device in an information processing system including the first device, a first virtual device that is a virtual device of the first device, a second device that is present within a predetermined distance from the first device, and a second virtual device that is a virtual device of the second device, the program causing a computer to execute processes of:
detecting the second device by communication using a predetermined short-range communication method; and
transmitting nearby device information for specifying the second device and recovery connection information used in a case where the second device connects to the first device, to the first virtual device, in a case of synchronizing with the first virtual device.

14. A non-transitory computer readable medium storing a program executed by a first device in an information processing system including the first device, a first virtual device that is a virtual device of the first device, a second device that is present within a predetermined distance from the first device, and a second virtual device that is a virtual device of the second device, the program causing a computer to execute processes of:
detecting the second device by communication using a predetermined short-range communication method; and
transmitting nearby device information for specifying the second device to the first virtual device, and transmitting recovery connection information used in a case where the second device connects to the first device, to the second device, in a case of synchronizing with the first virtual device.
